(19) United States
(12) Patent Application Publication
(10) Pub. No.: US 2022/0009191 A1
(43) Pub. Date: Jan. 13, 2022

(54) METHODS TO ENABLE THE FORMATION OF ORNAMENTAL CIRCLETS

(71) Applicant: Emi Shiga, Bellevue, WA (US)

(72) Inventor: Emi Shiga, Bellevue, WA (US)

(21) Appl. No.: 16/924,561

(22) Filed: Jul. 9, 2020

(51) Int. Cl. B31D 5/00

(52) U.S. Cl. CPC B31D 5/00

(57) ABSTRACT

A method to enable formation of ornamental circlets, comprising: forming a band that comprises a first end, a second end, a first ornamental motif positioned adjacent to the first end, and a second ornamental motif positioned adjacent to the second end; forming a tab in the first end adjacent to the first ornamental motif; forming a notch in the first end adjacent to the tab; forming slits in the second end adjacent to the second ornamental motif, twisting the band longitudinally 360 degrees; passing the slits through the notch to position the first ornamental motif under the second ornamental motif; and positioning the second ornamental motif under the tab. Forming the tab comprises forming the tab to have longitudinal symmetrically along the band. Forming the notch comprises forming the notch to angularly extend from a periphery of the band to the tab.

### FIELD OF THE INVENTION

The present disclosure relates generally to circlet. More specifically, the present disclosure describes methods to enable the formation of ornamental circlets.

### BACKGROUND OF THE INVENTION

Circlets are typically ring-shaped ornaments or articles of dress for the head or hand. For example, crowns are circlets that typically include decorative pendants and other embellishments. Similarly, bracelets, rings, necklaces, and headbands are each a type of circlet. Circlets may also be used to bind objects together or keep them in place (e.g., napkin holder). Current methods for making circlets typically require several separate components, which can increase manufacturing time and costs.

### BRIEF DESCRIPTION OF THE DRAWINGS

Some of the embodiments will be described in detail, with reference to the following figures, wherein like designations denote like members, wherein:

FIG. 1 depicts a top view of a circlet in its expanded state, according to some embodiments.

FIG. 2 depicts a step in the process of converting the circlet from the expanded state to its folded state according to other embodiments.

FIG. 3 depicts a step in the process of converting the circlet from the expanded state to its folded state, according to certain embodiments.

FIG. 4 depicts a step in the process of converting the circlet from the expanded state to its folded state, according to yet still other embodiments.

FIG. 5 depicts a step in the process of converting the circlet from the expanded state to its folded state, according to some embodiments.

FIG. 6 depicts a step in the process of converting the circlet from the expanded state to its folded state, according to other embodiments.

FIG. 7 illustrates the process steps of a method to enable the formation of decorative circlets, according to some embodiments.

FIG. 8 depicts an isometric view of a circlet, according to certain embodiments.

FIG. 9 depicts an isometric view of a circlet, according to yet still others embodiments.

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

The present disclosure relates generally to circlet. More specifically, the present disclosure describes methods to enable the formation of ornamental circlets. Circlets may also be used to bind objects together or keep them in place (e.g., napkin holder). Current methods for making circlets typically require several separate components, which can increase manufacturing complications, time, and costs. Such methods can make circlets that have three-dimensional ornaments, but they typically require more storage space compared to their two-dimensional counterparts. These methods also typically require the use of adhesives to hold the circlet together. The methods typically require specialized tools and skills for assembly, which make them more prone to human error.

The present disclosure includes many aspects and features. Moreover, while many aspects and features relate to, and are described in the context of methods to enable the formation of decorative circlets, embodiments of the present disclosure are not limited to use only in this context. The methods disclosed herein seek to provide circlets that do not require separate components or the use of adhesive material, which reduces manufacturing time and costs. The instant disclosure also seeks to provide methods that use substrates that are substantially flat and require a reduced space when stored in an expanded state. In certain aspects, the instant method yields circlets that can be used as bracelets, rings, headbands, neckless, napkin rings, table place cards, name tags, package wrappings, ornaments, displays, etc.

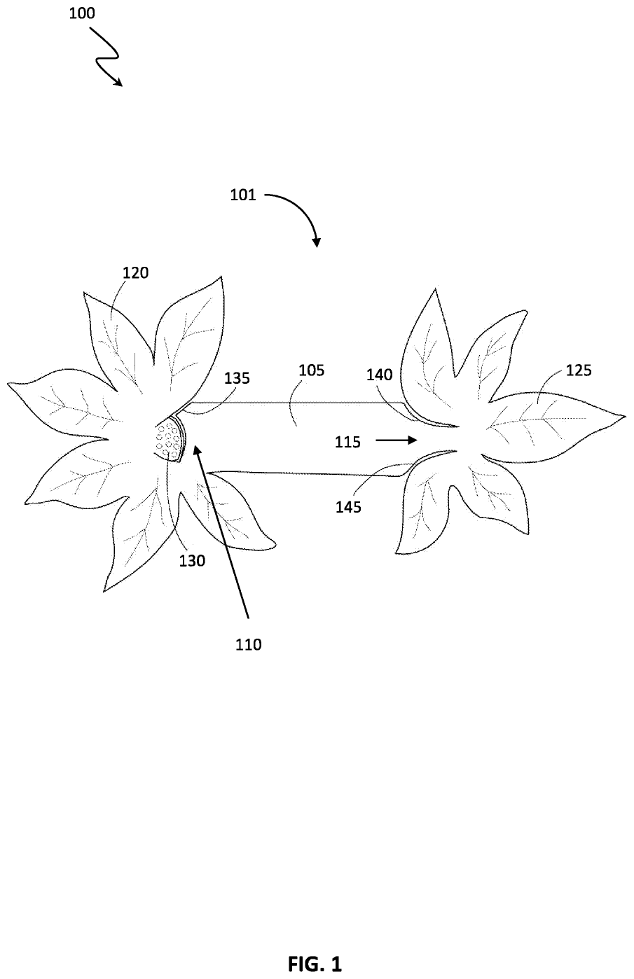

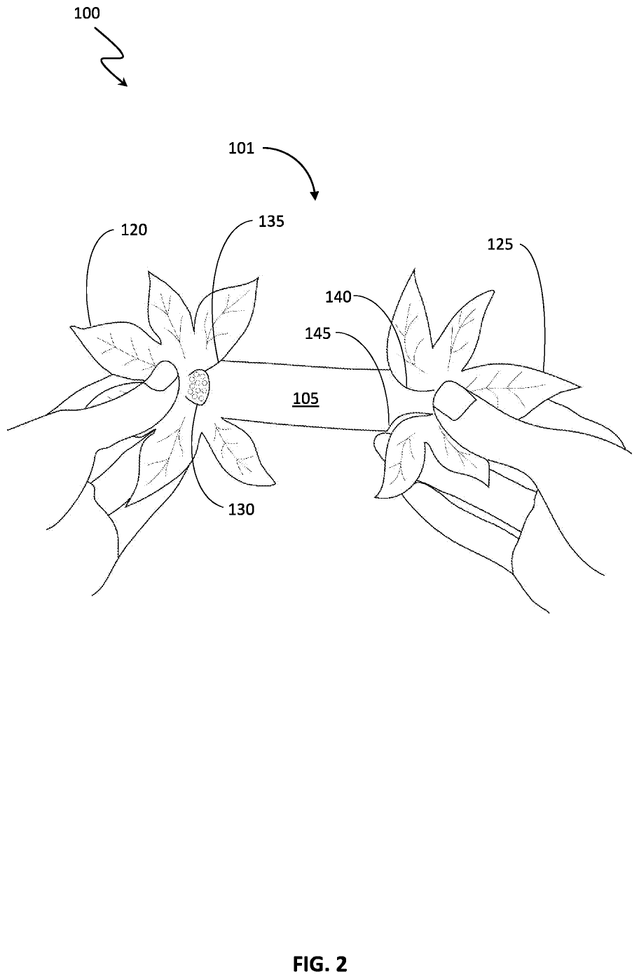

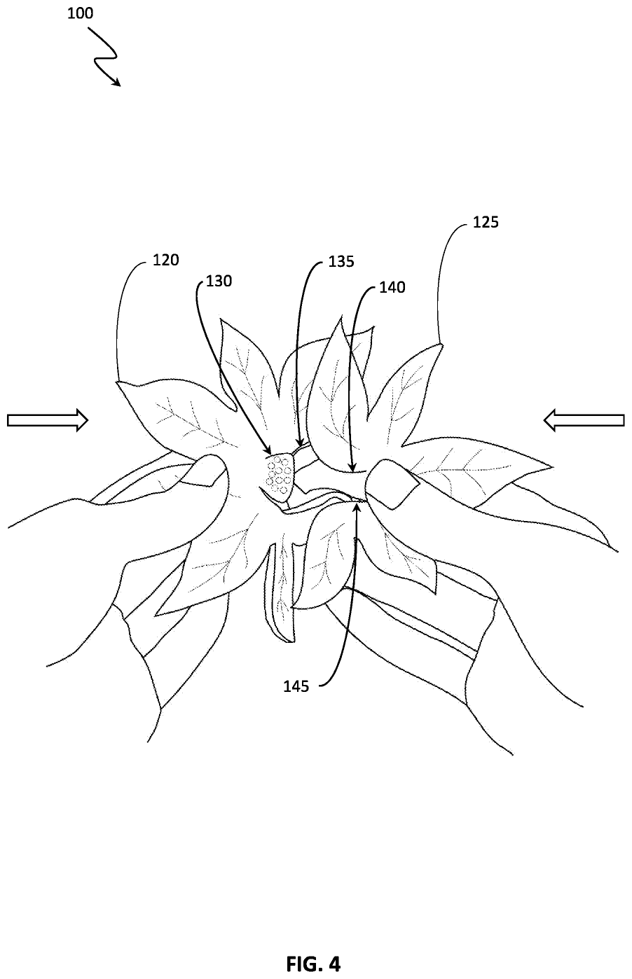

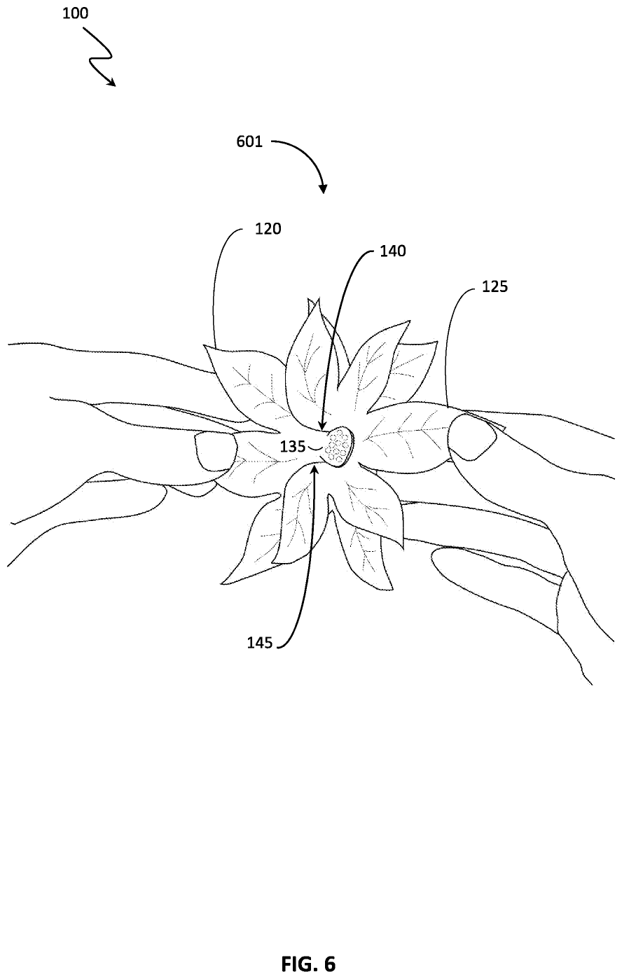

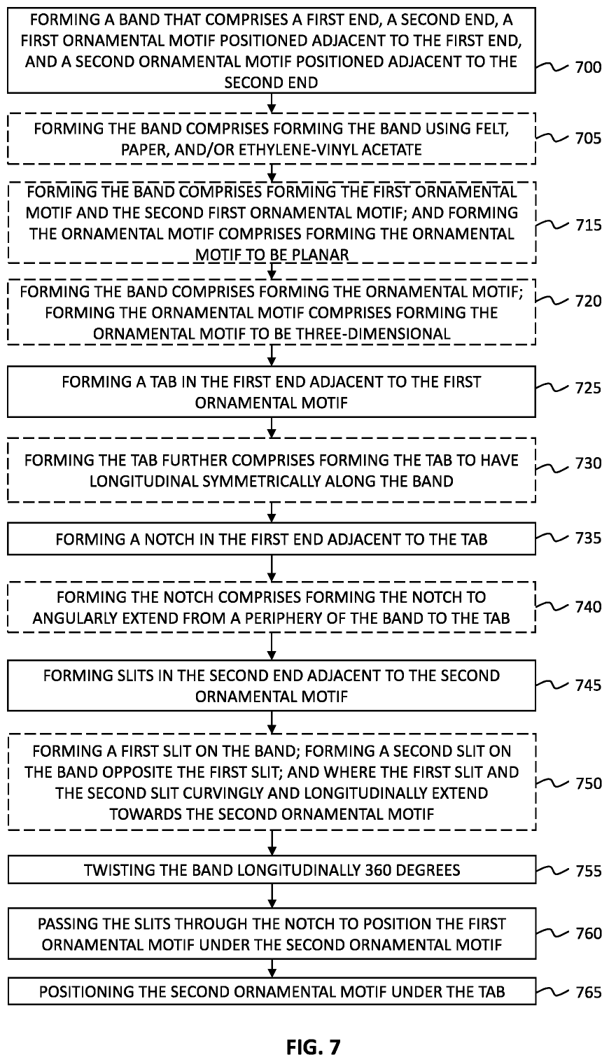

FIGS. 1-6 illustrate the processes of a method to enable the formation of decorative circlets, according to some embodiments. FIG. 7 illustrate the process steps of the method to enable the formation of decorative circlets, according to other embodiments. The decorative circlet (“circlet”) 100 is preferably a flat substantially planar structure that includes a first end 110, a second end 115, a first ornamental motif 120 positioned adjacent to the first end 110, and a second ornamental motif 125 positioned adjacent to the second end 115. The circlet 100 can be formed using a single piece of material. The circlet 100 preferably has an expanded state 101 (e.g., depicted in FIGS. 1 and 2) as well as a folded state 601 (e.g., depicted in FIGS. 6) At Step 700, a band 105 is formed that includes the first end 110, the second end 115, the first ornamental motif 120 positioned adjacent to the first end 110, and the second ornamental motif 125 positioned adjacent to the second end 115 (FIG. 1).

For example, the circlet 100 can be formed by cutting (e.g., die cutting and laser cutting), stamping, and/or similar processes. The circlet 100 can be formed from elastic or flexible material. The circlet 100 is preferably a continuous structure. The band 105 is preferably a substantially planar substrate. The band 105 is substantially planar to facilitate storage of the circlet 100 in its expanded state 101. Step 700 can be accomplished in a variety of different manners (e.g., Steps 705, 715, and 720). For example, at Step 705, the band 105 is formed using felt, paper, leather, sheet rubber (e.g., silicon or neoprene) and/or ethylene-vinyl acetate materials.

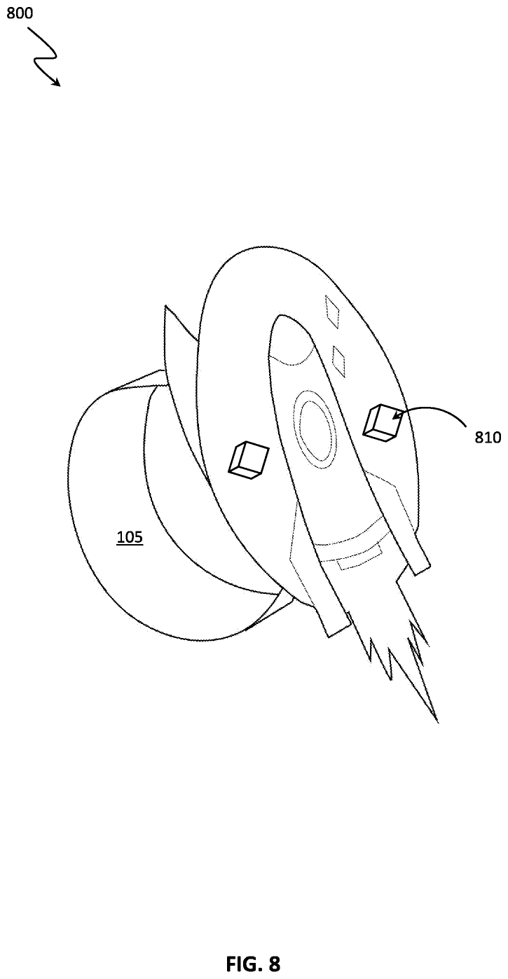

At Step 715, the first ornamental motif 120 and/or the second ornamental motif 125 are formed to be planar when the band 105 is formed. Alternatively, at Step 720, the first ornamental motif 120 and/or the second ornamental motif 125 are formed to be substantially three-dimensional when the band 105 is formed (e.g., they can include three-dimensional structure 810 of FIG. 8). At Step 725, a tab 130 is formed in the first end 110 adjacent to the first ornamental motif 120. For example, at Step 730, the tab 130 is formed to have longitudinal symmetry along the band 105. In some embodiments, the tab 130 is formed to have longitudinal asymmetry along the band 105. At Step 735, a notch 135 is formed in the first end 110 adjacent to the tab 130. In preferred embodiments, at Step 740, the notch 135 is formed to angularly extend from a periphery of the band 105 to the tab 130. At Step 745, slits (e.g., slit 140 and slit 145) are formed in the second end 115 adjacent to the second ornamental motif 125.

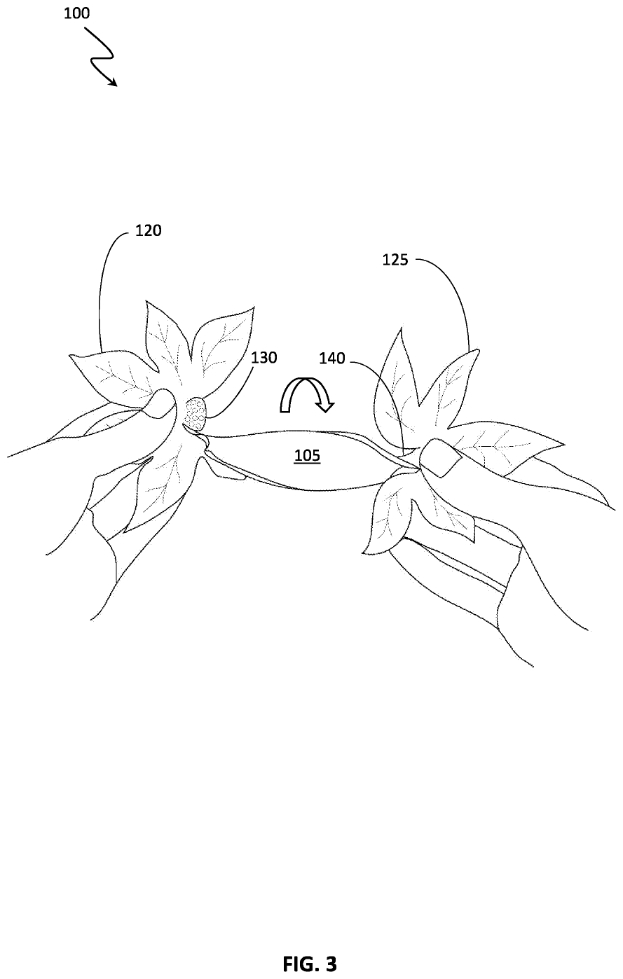

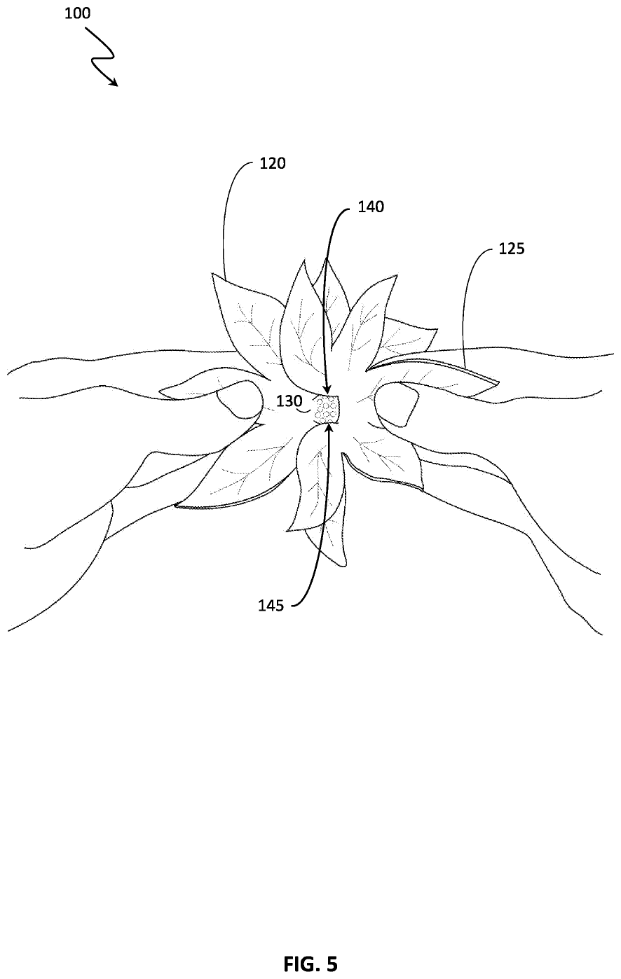

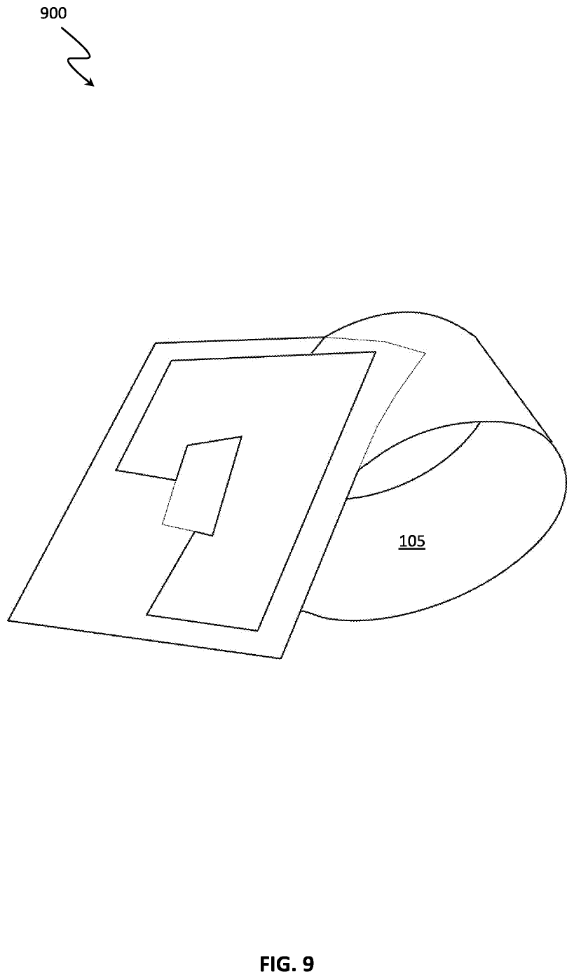

In preferred embodiments, at Step 750, a first slit 140 is formed on the band 105; a second slit 145 is formed on the band 105 opposite the first slit 140; and where the first slit 140 and the second slit 145 curvingly (or angularly) and longitudinally extend towards the second ornamental motif 125. As depicted in FIG. 3, at Step 755, the band 105 is twisted longitudinally 360 degrees. For example, one end of the band 105 can be held stationary while the other end is rotated 360° towards the user. At Step 760, the slits (e.g., the slit 140 and the slit 145) are passed through the notch 135 to position the first ornamental motif 120 under the second ornamental motif 125 (FIG. 5). At Step 765, the second ornamental motif 125 is positioned under the tab 130 (FIG. 6). FIGS. 8 and 9 depict circlets 800 and 900, respectively, which are types of the circlet 100 each having different ornamental motifs.

Although the disclosure has been explained in relation to its preferred embodiment, it is to be understood that many other possible modifications and variations can be made without departing from the spirit and scope of the disclosure.

What is claimed is:

1. A method to enable formation of ornamental circlets, comprising:
forming a band that comprises a first end, a second end, a first ornamental motif positioned adjacent to the first end, and a second ornamental motif positioned adjacent to the second end;
forming a tab in the first end adjacent to the first ornamental motif;
forming a notch in the first end adjacent to the tab;
forming slits in the second end adjacent to the second ornamental motif,
twisting the band longitudinally 360 degrees;
passing the slits through the notch to position the first ornamental motif under the second ornamental motif; and
positioning the second ornamental motif under the tab.

2. The method of claim 1, wherein forming the tab further comprises forming the tab to have longitudinal symmetrically along the band.

3. The method of claim 2, wherein forming the notch comprises forming the notch to angularly extend from a periphery of the band to the tab.

4. The method of claim 3, wherein forming the slits comprises:
forming a first slit on the band;
forming a second slit on the band opposite the first slit; and
where the first slit and the second slit curvingly and longitudinally extend towards the second ornamental motif.

5. The method of claim 4, wherein forming the band comprises forming the band using felt.

6. The method of claim 4, wherein the forming the band comprises forming the band using paper.

7. The method of claim 4, wherein forming the band comprises forming the band using ethylene-vinyl acetate.

8. The method of claim 4, wherein
forming the band comprises forming at least one the first ornamental motif and the second ornamental motif to be planar.

9. The method of claim 4, wherein
forming the band comprises forming at least one of the first ornamental motif and the second ornamental motif to be three-dimensional.

10. A method to enable formation of ornamental circlets, comprising:
forming a band that comprises a first end, a second end, a first ornamental motif positioned adjacent to the first end, and a second ornamental motif positioned adjacent to the second end;
forming a tab in the first end adjacent to the first ornamental motif;
forming a notch in the first end adjacent to the tab;
forming slits in the second end adjacent to the second ornamental motif,
twisting the band longitudinally 360 degrees;
passing the slits through the notch to position the first ornamental motif under the second ornamental motif;
positioning the second ornamental motif under the tab; and
wherein
forming the band comprises forming at least one of the first ornamental motif and the second ornamental motif to be planar.

11. The method of claim 10, wherein forming the tab further comprises forming the tab to have longitudinal symmetrically along the band.

12. The method of claim 11, wherein forming the notch comprises forming the notch to angularly extend from a periphery of the band to the tab.

13. The method of claim 12, wherein
forming the slits comprises:
forming a first slit on the band;
forming a second slit on the band opposite the first slit; and
the first slit and the second slit curvingly and longitudinally extend towards the second ornamental motif.

14. The method of claim 13, wherein forming the band comprises forming the band using felt, paper, or ethylene-vinyl acetate.

15. A method to enable formation of ornamental circlets, comprising:
forming a band that comprises a first end, a second end, a first ornamental motif positioned adjacent to the first end, and a second ornamental motif positioned adjacent to the second end;
forming a tab in the first end adjacent to the first ornamental motif;
forming a notch in the first end adjacent to the tab;
forming slits in the second end adjacent to the second ornamental motif,
twisting the band longitudinally 360 degrees
passing the slits through the notch to position the first ornamental motif under the second ornamental motif;
positioning the second ornamental motif under the tab; and
wherein
forming the band comprises forming the first ornamental motif and the second ornamental motif to be three-dimensional.

16. The method of claim 15, wherein forming the tab further comprises forming the tab symmetrically along a longitudinal axis of the band.

17. The method of claim 16, wherein forming the notch comprises forming the notch to angularly extend from a periphery of the band to the tab.

18. The method of claim 17, wherein
forming the slits comprises:
forming a first slit on the band;
forming a second slit on the band opposite the first slit; and
the first slit and the second slit curvingly and longitudinally extend towards the second ornamental motif.

19. The method of claim 18, wherein forming the band comprises forming the band using felt, paper, ethylene-vinyl acetate.
